(19) United States
(12) Patent Application Publication
(10) Pub. No.: US 2025/0284721 A1
(43) Pub. Date: Sep. 11, 2025

(54) Using Machine Learning Techniques To Improve The Quality And Performance Of Generative AI Applications

(71) Applicant: Oracle International Corporation, Redwood Shores, CA (US)

(72) Inventors: Sandeep R. Agrawal, San Jose, CA (US); Anatoly Yakovlev, Hayward, CA (US); Sanjay Jinturkar, Basking Ridge, NJ (US); Nipun Agarwal, Saratoga, CA (US)

(21) Appl. No.: 18/963,190

(22) Filed: Nov. 27, 2024

Related U.S. Application Data
(60) Provisional application No. 63/563,180, filed on Mar. 8, 2024.

(51) Int. Cl. G06F 16/334; G06F 16/3329; G06Q 30/0601

(52) U.S. Cl. CPC G06F 16/3344; G06F 16/3329; G06Q 30/0631

(57) ABSTRACT

A database system integrates in-database machine learning (ML) models with in-database large language models (LLMs) or other generative artificial intelligence (AI) models that enable new applications. The database system receives one or more inferences from an ML model and provides an inference input to a retrieval agent of an object store. One or more vector stores represent a plurality of reference documents using semantic encodings. The retrieval agent performs a similarity search of the one or more vector stores to retrieve a set of passages from the plurality of reference documents based on similarity of encodings of the inference input and encodings of passages in the plurality of reference documents. The database system generates a linguistic prompt for an LLM having a context including the inferences and passages and applies the LLM to the linguistic prompt to generate a natural language explanation of the one or more inferences.

### CROSS-REFERENCE TO RELATED APPLICATIONS; BENEFIT CLAIM

This application claims the benefit of Provisional Application 63/563,180, filed Mar. 8, 2024, the entire contents of which are hereby incorporated by reference as if fully set forth herein, under 35 U.S.C. § 119 (c).

### TECHNICAL FIELD

The present disclosure relates to the use of machine learning (ML) models and techniques to improve the speed and quality of generative artificial intelligence (AI) applications in a database system and, more particularly, to personalization and training of machine learning models using existing user data and using model predictions to filter context that is passed to large language models (LLMs).

### BACKGROUND

Generative artificial intelligence (generative AI, GenAI, or GAI) is artificial intelligence capable of generating text, images, videos, or other data using generative models, often in response to prompts. Generative AI models learn the patterns and structure of their input training data and then generate new data that has similar characteristics. Generative AI can benefit a wide range of industries, including software development, healthcare, finance, entertainment, customer service, sales and marketing, art, writing, fashion, and product design.

A large language model (LLM) is a computational model capable of language generation or other natural language processing tasks. As language models, LLMs acquire these abilities by learning statistical relationships from vast amounts of text during a self-supervised and semi-supervised training process. The largest and most capable LLMs are artificial neural networks built with a decoder-only transformer-based architecture, which enables efficient processing and generation of large-scale text data. Modern models can be fine-tuned for specific tasks or can be guided by prompt engineering.

For LLMs, the state-of-the-art solutions handcraft prompts for specific tasks or use cases. Much or all of the prompt is static and overgeneralized to accommodate limited variation during reuse. For example, generation of financial reports based on account activity would require a prompt that cannot be reused for a different use case, such as a prompt for a restaurant food recommendation, and either of those prompts may lack configurability for dynamic details. Furthermore, overgeneralized prompts may include all potential context information to handle all use cases. However, uses of an LLM with a long context result in a phenomenon referred to as “lost in the middle,” meaning that model performance is highest when relevant information occurs at the beginning (primacy bias) or the end (recency bias) of the input context, while model performance degrades when relevant information is in the middle of the context. These examples illustrate the difficulty of utilizing a generic prompt that works for all use cases. Thus, a state-of-the-art prompt causes LLM inferencing to have low semantic accuracy (e.g., wrong or irrelevant information) and low task accuracy (e.g., wrong format, kind, or scope of generated output) unless used for a narrowly predefined scenario.

System administrators consume a considerable amount of documentation, such as manuals, troubleshooting cheat sheets, frequently asked questions (FAQ) with answers, question-and-answer discussion websites, tutorials, weblog (blog) posts, and other knowledge bases to administer computers, networks, and software applications. A common entry point to consume such administrator support documentation is major search engines. However, finding high quality and up-to-date proprietary documentation using web search can be challenging. Search results often are diluted with other content and show outdated versions of proprietary documentation and guides. This problem also occurs with any public and versioned software stack and corresponding documentation.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 is a block diagram illustrating a database system with an in-memory query acceleration engine in accordance with an embodiment.

FIG. 2 is a block diagram illustrating prompt engineering for generative artificial intelligence using in-database machine learning in accordance with an embodiment.

FIG. 3 is a flowchart illustrating a machine language and generative artificial intelligence pipeline in accordance with an embodiment.

FIG. 4 depicts an example prompt template used to generate an engineered prompt in accordance with an embodiment.

FIG. 5 is a block diagram illustrating a database system with in-database machine learning and generative AI for providing an inferred summary based on an automatic trigger in accordance with an embodiment.

FIG. 6 is a block diagram illustrating a database system with in-database machine learning and generative AI for providing an inferred summary based on a manual trigger in accordance with an embodiment.

FIG. 7 is a block diagram that illustrates a computer system upon which aspects of the illustrative embodiments may be implemented.

FIG. 8 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The Oracle® HeatWave™ database system is an example of a fully managed database service, powered by an integrated in-memory query acceleration engine. The database service combines transactions, analytics, and machine learning services, delivering real-time, secure analytics without the complexity, latency, and cost of extract, transform, load (ETL) duplication. The Oracle® HeatWave™ database system also includes the HeatWave™ Lakehouse object storage, which allows users to query data stored in object storage in a variety of file formats.

The Oracle® HeatWave™ database system also includes the MySQL Autopilot™ machine learning (ML) automation component for improving the performance and scalability of the database system and in-memory query acceleration engine. The ML automation component provides many important and often challenging aspects of achieving high query performance at scale, including provisioning, data loading, query execution and failure handling. The ML automation component uses advanced techniques to sample data, collect statistics on data and queries, and build machine learning models to model memory usage, network load, and execution time. The ML automation component makes the in-memory query acceleration engine increasingly intelligent as more queries are executed, resulting in continually improving system performance over time.

The Oracle® HeatWave™ database system further includes generative artificial intelligence (AI) components that provide integrated and automated generative AI with in-database large language models (LLMs), an automated, in-database vector store, scale-out vector processing, and the ability to have contextual conversations in natural language. Users can use the in-database LLMs to help generate or summarize content based on unstructured documents. Users can ask questions in natural language via applications, and the LLM will process the request and deliver the content.

Current natural language processing (NLP) solutions provide generative functionality that is not proactive (i.e., autonomous). The cognitive load on the user is high with current solutions that require direct user interaction for problem solving purposes. The approaches of embodiments are more ergonomic because they expect less interaction from the user. Previous attempts at instrumenting document search have two main shortcomings rooted in a lack of proactivity. First, current generative AI solutions have no sense of timing and, thus, take no initiative. Second, current prompt generation consists of, or is based on, user interaction.

The illustrative embodiments combine learned automatic triggers and learned summarization to provide proactive generative automation to assist users with tasks. The embodiments integrate in-database machine learning (ML) models with in-database large language models (LLMs) or other generative artificial intelligence (AI) models that enables new applications, such as explaining anomalies or generating content from recommendations. Integrating with in-database ML models improves accuracy of LLM results by predicting relevant context in the input prompt. ML model integration also improves performance of LLM inference by pruning the search space and reducing the size of the input prompt.

In an embodiment, the database system accesses one or more inferences generated using a machine learning (ML) model and provides an inference input to a retrieval agent of an object store based on the one or more inferences. The object store includes one or more vector stores representing a plurality of reference documents using semantic encodings, also referred to herein as embeddings. The retrieval agent performs a similarity search of the one or more vector stores to retrieve a set of passages from the plurality of reference documents based at least in part on similarity of encodings of the inference input and encodings of passages in the plurality of reference documents. The database system generates a linguistic prompt for a large language model (LLM) having a context including the one or more inferences and the set of passages and applies the LLM to the linguistic prompt to generate a natural language explanation of the one or more inferences. The database system causes the natural language explanation of the one or more inferences to be displayed.

In one embodiment, the ML model is an ML-based recommendation system, and database system receives a natural language query including a request for a product recommendation from the user. The machine learning model generates the one or more inferences based at least in part on a profile of the user. The database system adds the natural language query to the linguistic prompt. The plurality of reference documents includes a plurality of product descriptions. The retrieval agent performs the similarity search based at least in part on the natural language query.

In an embodiment, the ML model is an anomaly detection system, which continuously monitors a series of logs and in response to detection of one or more anomalous logs in the series of logs, generates a trigger condition. The one or more inferences comprise the one or more anomalous logs. The linguistic prompt is generated in response to the trigger condition.

In one embodiment, the ML model comprises a fraud detection system, which continuously monitors a series of financial transactions and in response to detection of one or more anomalous transactions in the series of financial transactions, generates a trigger condition. The one or more inferences comprise the one or more anomalous transactions. The linguistic prompt is generated in response to the trigger condition.

Database System with in-Memory Query Acceleration

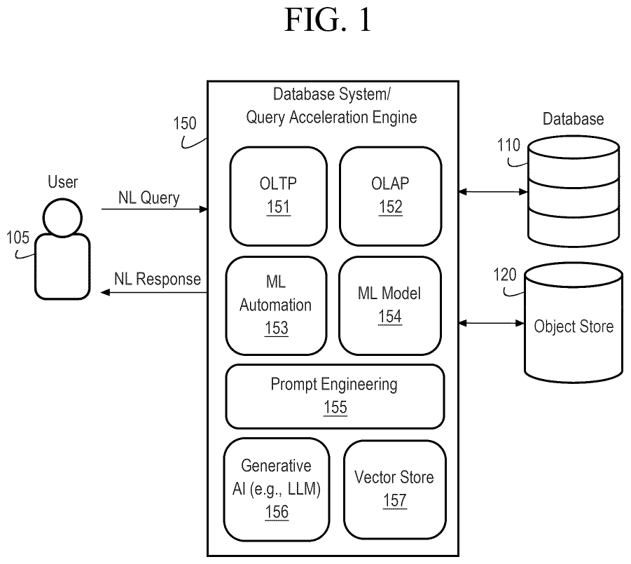

FIG. 1 is a block diagram illustrating a database system with an in-memory query acceleration engine in accordance with an embodiment. Database system 150 allows users, such as user 105, to search database 110 or object store 120. In an embodiment, database system 150 may be implemented as the MySQL open-source database or as Oracle InnoDB™ general-purpose storage engine. MySQL is a relational database management system (RDBMS), which stores data in separate tables rather than putting all the data in one big storeroom. The database structure is organized into files optimized for speed. The logical data model, with objects such as data tables, views, rows, and columns, offers a flexible programming environment. As the name implies, MySQL uses the structured query language (SQL), and a user may enter SQL queries directly, embed SQL statements into code in another language, or use a language-specific application programming interface (API) that hides the SQL syntax.

In an embodiment, database system 150 includes an in-memory query acceleration component. A non-limiting example of a database system with an in-memory query acceleration engine is the Oracle® HeatWave™ database system. Database system 150 includes online transaction processing (OLTP) component 151, online analytical processing (OLAP) component 152, ML automation component 153, ML models component 154, prompt engineering component 155, generative AI component 156, and vector store 157. OLTP is a type of data processing that consists of executing a number of transactions occurring concurrently. OLAP is a type of data processing for answering multi-dimensional analytical (MDA) queries. OLTP component 151 allows users to run OLTP workloads on database 110, and OLAP component 152 allows users to run OLAP workloads.

### ML Automation

ML automation component 153 analyzes data related to database operations, including information on queries, data loading, and resource utilization. ML automation component 153 generates and analyzes intensive data about a database, including static information, such as schema details, and dynamic information, such as content statistics. ML automation component 153 also includes ML models that predict resource usage and query performance. Thus, ML automation component 153 has ample ML infrastructure that has more or less direct access to a database schema, content statistics, and usage statistics. This integration makes the ML automation suitable for implementing database ML innovations and insight models.

ML automation component 153 uses advanced machine learning techniques to automate the database system 150 and in-memory query acceleration and to improve performance and scalability. A non-limiting example of an ML automation component is the Oracle® HeatWave™ Autopilot ML automation component. The ML automation component 153 focuses on four aspects of the service lifecycle: system setup, data load, query execution, and failure handling. ML automation component 153 includes the following capabilities:
Auto provisioning predicts the number of compute nodes required for running a workload by adaptive sampling of table data on which analytics is required. This means that customers no longer need to manually estimate the optimal size of the cluster.
Auto parallel load optimizes the load time and memory usage by predicting the optimal degree of parallelism for each table being loaded into the database system 150.
Auto data placement predicts the column on which tables should be partitioned in-memory to help achieve the best performance for queries. It also predicts the expected gain in query performance with the new column recommendation. This minimizes data movement across nodes due to suboptimal choices that can be made by operators when manually selecting the column.
Auto encoding determines the optimal representation of columns being loaded into the database system 150, taking the queries into consideration. This optimal representation provides the best query performance and minimizes the size of the cluster to minimize costs.
Auto query plan improvement learns various statistics from the execution of queries and can improve the execution plan of future queries. This improves the performance of the system as more queries are run.
Auto query time estimation estimates the execution time of a query prior to executing the query. This provides a prediction of how long a query will take, enabling customers to decide if the duration of the query is too long and instead run a different query.
Auto change propagation intelligently determines the optimal time when changes in MySQL database should be propagated to the database system's scale-out data management layer. This helps ensure that changes are being propagated at the right optimal cadence.
Auto scheduling determines which queries in the queue are short running and prioritizes them over long running queries in an intelligent way to reduce overall wait time. Most other database systems use the First In, First Out (FIFO) mechanism for scheduling.
Auto error recovery provisions new nodes and reloads necessary data if one or more database system nodes are unresponsive due to software or hardware failure.

Thus, ML automation component 153 uses ML techniques to implement or improve system setup, data load, query execution, and failure handling using statistics and model predictions or classifications. These statistics may include, for example, user-specific workload statistics, overall workload statistics, database table statistics, query performance statistics, etc.

### In-Database ML Models

ML model component 154 supports in-database machine learning (ML) to fully automate the ML lifecycle and store all trained models inside the MySQL database 110, eliminating the need to move data or the model to a machine learning tool or service. ML model component 154 provides the following capabilities compared to other cloud database services:
Fully Automated Model Training: All of the different stages in creating a model with ML model component 154 are fully automated and do not require any intervention from developers. This results in a tuned model that is more accurate, requires no manual work, and ensures the training process is always completed.
Model and Inference Explanations: Model explainability helps developers understand the behavior of a machine learning model. Prediction explainability is a set of techniques that help answer the question of why a machine learning model made a specific prediction. ML model component 154 integrates both model explanation and prediction explanations as a part of its model training process.
Hyper-Parameter Tuning: ML model component 154 implements a new gradient search-based reduction algorithm for hyper-parameter tuning. This enables the hyper-parameter search to be executed in parallel without compromising the model accuracy. Hyper-parameter tuning is the most time-consuming stage of ML model training, and this unique capability provides a significant performance advantage over other cloud services for building machine learning models.
Algorithm Selection: ML model component 154 uses the notion of proxy models, which are simple models exhibiting the properties of a full complex model, to determine the best ML algorithm for training. Using a simple proxy model, algorithm selection is done very efficiently without loss of accuracy.
Intelligent Data Sampling: During model training, ML model component 154 samples a small percentage of the data in order to improve performance. This sampling is done in such a manner that all representative data points are captured in the sample data set.
Feature Selection: Feature selection helps determine the attributes of the training data which influence the machine learning model behavior for making predictions. The techniques in ML model component 154 for feature selection have been trained over a broad swath of data sets across multiple domains and applications. From these gathered statistics and meta information, ML model component 154 is able to efficiently identify the relevant features in a new data set.

Thus, ML model component 154 provides capabilities for ML model training, tuning, and implementation.

### Generative AI

Generative AI component 156 is an integrated platform that combines generative artificial intelligence (AI) with the existing in-memory database technology of database system 150. Generative AI component 156 is specifically integrated with the MySQL database service. Generative AI component 156 leverages the in-memory architecture of the database system 150 to provide efficient processing for the large language models (LLMs) and vector store 157 that power its generative AI capabilities.

In some embodiments, generative AI component 156 uses in-database, optimized LLMs to instantly benefit from generative AI, and have contextual conversations informed by unstructured documents using natural language. Generative AI component 156 may achieve more accurate and contextually relevant answers by letting LLMs search proprietary documents, without AI expertise or moving data to a separate vector database. Vector store 157 is integrated and automates encoding generation. Generative AI component 156 generates natural language or other output using data in object store 120 and MySQL database 110.

### Vector Store

With support for generative AI, users 105 can interact with database system 150 in natural language. Both the user queries and the response from the system can be generated in natural language using a Large Language Model (LLM). In some embodiments, LLMs are trained on public data, and for organizations looking to leverage LLM capabilities for enterprise data, the results can be incorrect due to the hallucination problem of LLMs, and lack of enterprise knowledge. In order to mitigate this problem, database system 150 includes vector store 157.

Vector store 157 uses a language encoder to create vector encodings from documents, which can be stored in variety of formats. Vector store 157 also takes the question asked by the user to create vector encodings and does a similarity search in an n-dimensional space. The output of the vector store is context, included along with the users' question in a prompt, which is the input to the LLM. The LLM uses this information to generate a response, which now includes proprietary information from the documents in object store 120.

In one embodiment, vector store 157 represents each passage of documents in object store 120 as a vector, which can be stored as a row in a database table. For instance, each passage may be a paragraph in a document, and the vector may include a document identifier, an author, a publication date, a chapter identifier, a page number, an offset of the paragraph on the page, and an encoding of the text of the passage, also referred to herein as an embedding. Thus, for a given document, the rows for passages of the given document will have unique encodings for the passages; however, the document identifier (or document encoding) will be the same. This allows the system to filter by document, date, author, etc., and then perform a similarity search for passages. The manner in which passages are represented may vary depending on the implementation. In an embodiment, the vector representations are stored in database 110. Vector store 157 provides very fast searching of unstructured data by providing encodings that are searched by similarity score rather than pattern matching, which can be slow and very resource intensive. In some embodiments, passages from vector store 157 can be provided as context in a prompt.

### Prompt Engineering and Augmentation

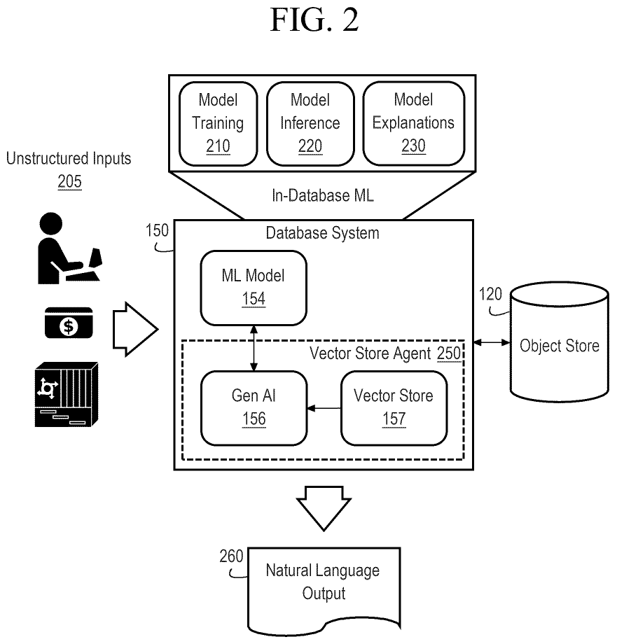

FIG. 2 is a block diagram illustrating generative artificial intelligence using in-database machine learning in accordance with an embodiment. In one embodiment, database system 150 performs activities described above with respect to prompt engineering component 155 in FIG. 1 to generate a prompt for generative AI. The database system 150 receives unstructured inputs 205, such as a natural language query from a user, text logs, financial transaction logs, etc. ML model component 154 provides in-database machine learning.

In-database machine learning refers to the integration of machine learning algorithms and techniques into a database management system. All processes, including data set selection, training algorithms, and evaluating models, stay within the database. With in-database machine learning, organizations can perform complex analytical tasks directly within their databases, eliminating the need to move data between systems, thus removing the latency, data integrity, and security concerns involved with data import/export processes. ML model component 154 can perform ML training 210, model inference 220, and model explanations 230 inside the database, using SQL.

All of the different stages in creating a model with ML model component 154 are fully automated and do not require intervention from developers. Model explainability helps developers understand the behavior of a machine learning model. Prediction explainability is a set of techniques that help answer the question of why a machine learning model made a specific prediction. ML model component 154 integrates both model explanation and prediction explanations as a part of its model training process. As a result, all models created by ML model component 154 can offer models as well as inference explanations without requiring training data at inference explanation time.

The prompt engineering has a preparation phase followed by a generative phase. Both phases may configure or use ML model component 154, including at least one of: an encoder model, a generative model, an anomaly detection model, a data classification model, a measurement regression model, or a reference classification model. Any of those models may be a machine learning model or a heuristic model. The encoder model, the reference classification model, and the generative model may generate inferences that are highly personalized. All of the models generate inferences that are highly contextualized (i.e., dynamic). Personalization and contextualization increase the semantic accuracy of inferences.

The preparation phase creates a knowledge index of existing structured (e.g., JSON, XML, and HTML) and unstructured (e.g., prose, word processing documents) reference documents from object store 120 represented in a vector store 157 or an indexed database. Whether structured or unstructured, a document may partially or entirely contain natural language, such as multiword terms, phrases, sentences, and paragraphs. Each reference document has a fixed-size dense semantic encoding that may, for example, be inferred by the encoder model that uses natural language processing (NLP) to accept an input document as a sequence of lexical tokens. For example, the encoder model may be an LLM, such as bidirectional encoder representation from transformers (BERT). In an embodiment, vector store 157 associates each reference document with its fixed-size encoding that represents the document, referred to as a reference encoding.

The preparation phase creates triggers that conditionally invoke the generative phase. These triggers detect special circumstances, such as an aberrant operational condition or an operational decision point. Each trigger has a respective observation mode that may be one of: (a) a continuous monitoring of fluctuating telemetry, (b) periodic inspection, polling, or sampling of data or status, or (c) event driven. Periodic observation may be scheduled. Event driven observation is reactive to a human interaction or automatic alert, an action of a workflow manager or a rule executed by a rules engine, or an operational process or script, such as an installation, maintenance, failover, rebalancing, or deployment migration from one host to another.

An occurrence by a trigger may be a positive detection by an anomaly detection model, a particular class from the data classification model, or a threshold exceeded by a score from the measurement regression model. A reaction to an occurrence of a trigger can dynamically generate a reaction context, which may entail: (a) data gathering and representation of a dynamic operational context and a current system state and (b) for personalization, retrieval of a profile or history of a user or account. Gathering the current system state may entail: (a) inclusion or mining of operational logs, (b) generation and inclusion of diagnostic output, and (c) database retrieval or analytics. Dynamic operational context may be text (e.g., commands and console output) in a shell (e.g., console), an exception stack trace, or a document or webpage already displayed in a web browser or a word processor.

In an embodiment, an occurrence of a trigger causes sequentially: a) the reference classification model accepting the reaction context as input and then b) the reference classification model inferring (i.e., classifying) a subject matter topic and/or a document kind. Document kinds may be manuals, troubleshooting cheat sheets, frequently asked question documents (FAQs) with answers, question-and-answer discussion websites, tutorials, or weblog (blog) posts. The output of the reference classification model is referred to as a reference category.

In some embodiments, the reaction context and the reference category may or may not contain natural language. A combination of the reaction context and the reference category is referred to as a search key. An occurrence by a trigger causes the generative phase that has a search stage followed by a prompt stage. In an embodiment, the generative phase is performed by vector store agent 250, which is a program or process that uses content retrieval to enhance analytics, decisioning, and/or task reasoning. In an embodiment, vector store agent 250 includes a ReAct system and can use any reactive or assistive technique presented in “ReAct: a system for recommending actions for rapid resolution of IT service incidents,” by Vishalaksh Aggarwal et al in 2016 IEEE International Conference on Services Computing (SCC), which is incorporated in its entirety herein. ReAct is a JavaScript framework used to build web applications.

The search stage may entail sequentially: (a) generating a sequence of lexical tokens that represents the search key, (b) the encoder model accepting the tokens sequence as input, (c) the encoder model inferring a fixed-size encoding that represents the tokens sequence, referred to herein as the search encoding, (d) the knowledge index accepting the search encoding as a lookup key, and (e) the knowledge index selecting and returning reference document(s) represented by the nearest (i.e., semantically most similar), relative to the search encoding, one or few already stored reference encodings. In an embodiment, selecting and returning reference documents are accelerated because the search key limits the scope of the search for matching reference documents.

Similarity may be measured by semantic distance, such as multidimensional-space vector distance (e.g., Euclidian or Manhattan). For example, the knowledge index may implement nearest neighbor search. The output of the search stage is a dynamically selected set of highly relevant (i.e., semantically similar) reference documents, referred to herein as matching documents because they semantically match the search key. For example, the matching documents may be ranked (i.e., sorted) by similarity score such as measured semantic distance, and that score (i.e., distance) is based on comparison of a reference encoding to the search encoding, which does not entail accessing the reference document represented by the reference encoding. However, techniques described herein do not require ranking.

The prompt stage entails sequentially: (a) generating (e.g., by vector store agent 250 using a generative model, such as using generative AI component 156, which may be an LLM) a linguistic prompt based on the search key and the matching documents, (b) the generative model (e.g., generative AI component 156) accepting the linguistic prompt as input, and (c) the generative model inferring (i.e., generating) natural language, shown as natural language output 260 in FIG. 2. The generative model may perform summarization (e.g., of a problem) and/or recommendation (e.g., of a solution such as an action plan). For example, a recommendation may contain ranked matching documents as discussed above.

### Generative AI Pipeline

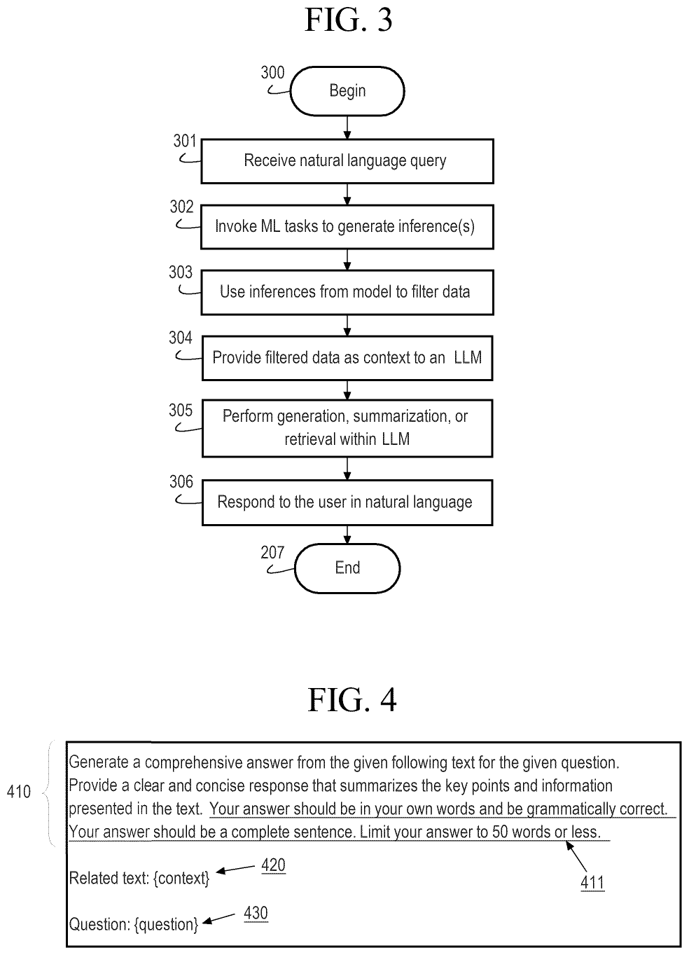

FIG. 3 is a flowchart illustrating a machine language and generative artificial intelligence pipeline in accordance with an embodiment. The ML and generative AI pipeline uses in-database ML models and generative AI, such as an LLM. The in-database ML models support classification, regression, forecasting, anomaly detection, and recommendation models. The database system provides generative AI and a vector store. The ML and generative AI pipeline operates in the generative phase discussed above. In some embodiments, the ML and generative AI pipeline is invoked based on a condition and task (e.g., classification, regression, anomaly detection, forecasting, or recommendation). Depending on the use case, the ML and generative AI pipeline can be triggered manually or automatically. Triggers are discussed above.

Operation begins (block 300), and the database system receives a natural language query from a user (block 301). There may be two kinds of linguistic prompts: an interactive question or an engineered prompt. In a manual trigger embodiment, the trigger may be the user submitting a query (i.e., an interactive question) consisting of natural language, which invokes one of the ML model component tasks for prediction. In an automatic trigger embodiment, block 301 is optional or unimplemented, in which case the trigger is automatic as discussed above and entails an ML model providing an inference (e.g., anomaly detection, classification, etc.).

The database system invokes ML tasks to generate one or more inferences (block 302). In some embodiments, the ML model is an LLM that accepts a sequence of linguistic tokens as input. The token sequence may include the reaction context discussed above and, only if optional block 301 occurs, the interactive question that increases semantic accuracy of contextual inferencing. The ML model of block 302 may be at least one of an anomaly detection model, a data classification model, a measurement regression model, or a reference classification model, as discussed above.

The database system uses inferences from the ML model to filter data (block 303), which is the search stage described above. That is, the database system uses the inferences from the ML model to search for context for the prompt being generated. As an example, in the manual trigger embodiment, the ML model may perform predictions based on the interactive question. For instance, ML automation may perform a prediction based on workflow statistics of the user asking the interactive question. In one embodiment, the ML model may be a recommendation system, and the inference may be recommendations (i.e., predictions) for the user based on the interactive question. Alternatively, or in addition, an ML model may be an encoder that generates a search encoding, and the database system may use the search encoding to search structured and unstructured documents for passages that are semantically similar to the interactive question based on comparison of the search encoding to one or more reference encodings, as described in further detail above.

In the automatic trigger case, the ML model may perform anomaly detection. For instance, an anomaly detection model can receive application logs as input and generate one or more inferences identifying anomalous logs. Alternatively, an anomaly detection model can receive financial transaction data as input and identify transactions as fraudulent (i.e., anomalous). The database system may then use these inferences (e.g., anomalous logs or fraudulent transactions) to perform a search and filter structured and unstructured documents based on the inferences. Again, ML automation may perform a prediction based on workflow statistics of the user asking the interactive question. For example, in the case of anomaly detection of application logs, ML automation may perform predictions based on user workflow statistics that may be relevant to the anomalous logs.

In the prompt stage, the database system provides the filtered data as context to an LLM (block 304), performs generation, summarization, or retrieval within the LLM (block 305), and responds to the user in natural language (block 306). Thereafter, operation ends (block 307). Blocks 304-306 comprise the prompt stage. In an embodiment, the ML and generative AI pipeline continuously generates predictions for the provided task and causes a generative AI inference call. The result of block 305 is a generative inference by the generative model (e.g., LLM). Block 306 causes the result to be displayed to the user in natural language.

FIG. 4 depicts an example prompt template used to generate an engineered prompt in accordance with an embodiment. The prompt template consists of a vertical sequence of three horizontal bands of text. The top text band 410 is prose (i.e., multiple natural language sentences) that consists of a command (i.e., task) sentence and one or more guardrail sentences 411 that constrain the task. The command and guardrails specify a task for the generative model to perform. In an embodiment, the top text band is static (i.e., predefined) and does not depend on personalization or contextualization. The middle text band may contain the search key and/or whole or semantically relevant portions of the matching documents, shown as related text or context 420. The bottom text band contains the interactive question 430. Each text band may be preceded by a predefined distinct label such as shown. The middle 420 and bottom 430 text bands are dynamic, personalized, and contextual.

### Example Implementations—Automatic Trigger

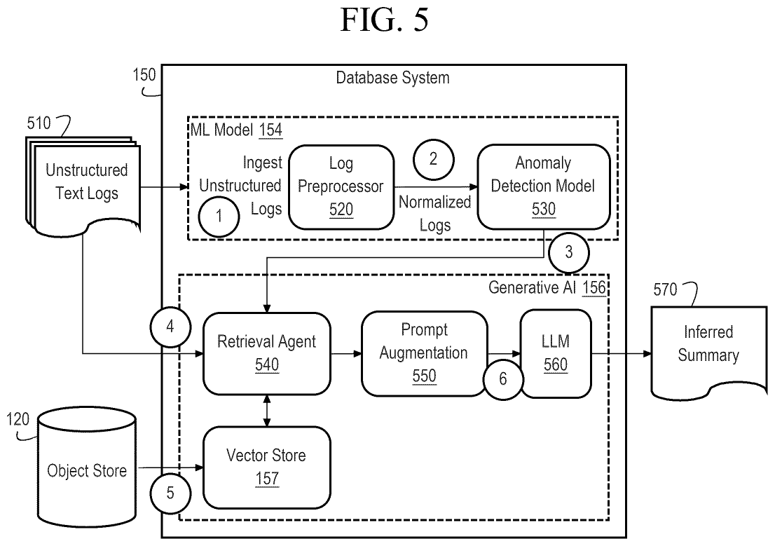

FIG. 5 is a block diagram illustrating a database system with in-database machine learning and generative AI for providing an inferred summary based on an automatic trigger in accordance with an embodiment. The automatic trigger implementation provides an application that uses a combination of (a) an ML model, such as anomaly detection model 530 in FIG. 5, and a retrieval augmented generation (RAG) agent, or retrieval agent 540 (i.e., the encoder model and the knowledge index), and (b) a summarization LLM 560 (i.e., the generative model).

ML model component 154 trains and implements an anomaly detection model 530, which provides an assistive system for service technicians, such as a system administrator, a network administrator, a database administrator, or an administrator of a cloud application. In step 1, log processor 520 ingests logs 510. For example, a log may be a text file or a database table, and an entry in a log may be a line of text or a table row. In step 2, anomaly detection model 530 generates an inference that represents detected or predicted anomalous logs within logs 510.

In some embodiments, ML model component 154 may also train and implement explainer models (not shown) that indicate which features (e.g., columns or fields in the logs) caused anomaly scores to be high for particular anomalous logs. This information can also be provided to generative AI component 156 to be used in the generative phase. Thus, the inference provided by ML model component 154 to generative AI component 156 can include a prediction (e.g., anomaly detection, recommendation) and an explanation of the prediction.

In the generative phase, the generative AI component 156 includes retrieval agent 540 (e.g., the vector store agent), the vector store 157, a prompt augmentation component 550 (e.g., the prompt engineering component 155), and LLM 560 (i.e., the generative model). In some embodiments, vector store 157 includes a similarity search component, for performing a similarity search between one or more search encodings and one or more reference encodings, and a language encoder (i.e., an encoder model), for generating encodings.

In step 3, upon an occurrence of the automatic trigger, which is detection of one or more anomalous logs, an alert is sent to generative AI component 156 to cause the generative phase. In step 4, retrieval agent 540 generates a context based on the inference received from anomaly detection model 530 and optionally a user query.

In some embodiments, structured and/or unstructured documents in object store 120 are ingested into the vector store in a preparation phase (shown as step 5, although this step is performed prior to the generation phase in most cases). Therefore, the reference encodings are generated in the preparation phase. As a result, the semantic search is very fast, because vector store 157 performs a similarity search of encodings based on semantic distance, such as multidimensional-space vector distance (e.g., Euclidian or Manhattan), rather than performing pattern matching on the documents themselves. That is, vector store 157 and retrieval agent 540 do not attempt to find documents that contain the terms from the anomalous logs; rather, vector store 157 and retrieval agent 540 attempt to find the top N documents or passages that are semantically similar to the inference provided by anomaly detection model 530, and optionally a query provided by the user, where N is a predefined threshold parameter. Retrieval agent 540 filters the documents or passages to narrow the context for LLM 560, thus improving speed and accuracy.

In step 6, prompt augmentation component 550 provides results of the similarity search, as well as results from ML automation in some embodiments, as context to the detected anomalous logs to generate and augment a prompt for LLM 560. In one embodiment, a prompt template is used, such as the prompt template shown in FIG. 4. The result of the similarity search can be provided in the context portion 420, and the user's query, if any, can be provided in the question portion 430. In one embodiment, question portion 430 may also be a template for a given use case. For example, an example question may be as follows: “what are some possible problems associated with the anomalous logs, possible causes, and potential mitigating actions that can be performed to solve those problems?” In another embodiment, the prompt template may be customized for each use case.

In step 6, LLM 560 generates an inference in the form of inferred summary 570, which summarizes, in natural language, the input for the user. This helps the operator to quickly diagnose the state of the system, and easily identify the cause of the anomaly. The embodiment provides improved ergonomics of assistive automation. As used herein, ergonomics is a quantitative performance metric that may be based on one, some, or all of the following measurements: time spent reading and understanding the inferred summary, time spent using the summary for root cause analysis, time spent formulating a remedial plan, system downtime, amount of data lost or corrupted, and a count of applications or end users impacted by downtime. All of those measurements are decreased by this generative AI application due to the increased relevance (i.e., accuracy) of the inferred summary 570. The inferred summary may contain: (a) prose comprising tactical and strategic instructions to the user and (b) summaries, excerpts, or hyperlinks of matched documents.

### Example Use Case—Predictive Maintenance

In some embodiments, the logs 510 may be logs from a computer system, such as a database system, a cloud application, or any system that generates logs. In one embodiment, a user may enter a query, such as “what is wrong with my system?” or “why is memory usage spiking?” In this case, the user's query can trigger the generative phase. Alternatively, anomaly detection model 530 can trigger the generative phase whenever anomalous logs are detected or based on a set of rules. For example, the generative phase may be triggered if a predetermined number of anomalous logs are detected.

In some embodiments, object store 120 contains knowledge base logs, bug database records, project management documents, etc. Thus, retrieval agent 540 narrows the search of vector store 157 to documents and passages that are relevant to the detected anomalous logs. Retrieval agent 540 may also consider information provided by ML automation, such as workload, database schemas, etc. This information may also be used to contextualize the context to the most likely causes of a given anomaly.

In some embodiments, inferred summary 570 includes inferences that are relevant to the detected anomalous logs. For example, inferred summary 570 can be incident reports in natural language. Such incident reports can include root cause analysis (RCA) based on knowledge from documents in object store 120. In one embodiment, inferred summary 570 can include an actionable resolution or mitigation plan for addressing a cause of an incident and/or mitigating problems caused by an incident.

### Example Use Case—Financial Analysis and Fraud Detection

In some embodiments, the logs 510 may be financial records of one or more individuals. In one embodiment, a user may enter a query, such as “how can we improve cash flow?” or “what is suspicious about this account?” In this case, the user's query can trigger the generative phase. Alternatively, anomaly detection model 530 can trigger the generative phase whenever anomalous logs are detected or based on a set of rules. For example, the generative phase may be triggered if a predetermined number of anomalous logs are detected, which may indicate fraudulent activity, for example.

In some embodiments, object store 120 contains a knowledge base of financial information that may help explain detected anomalous logs. Thus, retrieval agent 540 narrows the search of vector store 157 to documents and passages that are relevant to the detected anomalous logs. Retrieval agent 540 may also consider information provided by ML automation, such as workload, database schemas, etc. This information may also be used to contextualize the context to the most likely causes of a given anomaly. For example, if anomalous logs indicate potentially fraudulent activity involving multiple credit cards, retrieval agent 540 can provide context that is relevant to credit card fraud. Thus, inferred summary 570 can explain why anomalous logs may indicate that an individual is committing credit card fraud.

### Example Implementations—Manual Trigger

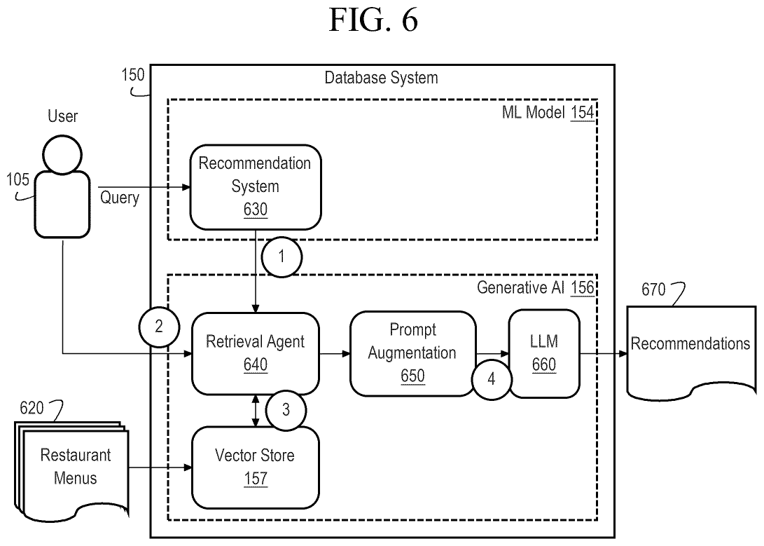

FIG. 6 is a block diagram illustrating a database system with in-database machine learning and generative AI for providing an inferred summary based on a manual trigger in accordance with an embodiment. The manual trigger implementation provides an application that uses a combination of (a) a user-interfacing ML model, such as a recommendation system 630 in FIG. 6, and a retrieval augmented generation (RAG) agent, or retrieval agent 640 (i.e., the encoder model and the knowledge index), and (b) a summarization LLM 660 (i.e., the generative model).

In the depicted example, ML model component 154 trains and implements recommendation system 630, which provides recommendations for a user 105 based on a query. Recommendation system 630 may contain an ML model that is trained with or accepts as input: (a) personalization data, such as a profile or history of a user or account, (b) explicit feedback, such as ratings and comments provided by users, and (c) implicit feedback such as historic interactions, such as clicks and purchases. The output of recommendation system 630 is an inference, e.g., a ranked set of recommended restaurants. This output is highly personalized.

In some embodiments, the query is a natural language query, such as “list vegan menu items,” for example. In step 1, recommendation system 630 inspects the user's prior history of restaurants and the user's profile to dynamically identify the top (i.e., most semantically relevant, for example, the most semantically aligned with the user's preferences and/or most semantically similar to the user's history) restaurants in which the user may be interested. A recommendation can be highly contextual. For instance, recommendation system 630 may not recommend an ice cream parlor on a cold day based on results of ML models trained and implemented by ML model component 154. The recommended restaurants then act as a trigger of the generative phase.

In the generative phase, the generative AI component 156 includes retrieval agent 640 (e.g., the vector store agent), the vector store 157, a prompt augmentation component 650 (e.g., the prompt engineering component 155), and LLM 660 (i.e., the generative model). In some embodiments, vector store 157 includes a similarity search component, for performing a similarity search between one or more search encodings and one or more reference encodings, and a language encoder (i.e., an encoder model), for generating encodings.

In step 1, the ML model, in this case recommendation system 630, generates an inference, such as a recommendation. For example, in response to the query, “list vegan menu items,” recommendation system 630 generates one or more restaurant recommendations based on a history and preferences of user 105. In step 2, retrieval agent 640 accesses the inference generated using the recommendation system 630 and the query from user 105. Then, in step 3, vector store 157 generates one or more search encodings or embeddings from the query and the restaurant recommendations and performs a semantic search of restaurant menus 620. This provides context that is provided to prompt augmentation component 650 in addition to the query.

In some embodiments, restaurant menus 620 (i.e., reference documents) are ingested into the vector store in a preparation phase. Therefore, the reference encodings are generated in the preparation phase. As a result, the semantic search is very fast, because vector store 157 performs a similarity search of encodings based on semantic distance, such as multidimensional-space vector distance (e.g., Euclidian, Manhattan, or cosine similarity), rather than performing pattern matching on the restaurant menus themselves. That is, vector store 157 and retrieval agent 640 do not attempt to find restaurant menus, or restaurant menu items, that contain the search query terms; rather, vector store 157 and retrieval agent 640 attempt to find the top N restaurant menus, or restaurant menu items, that are semantically similar to the query and the inference generated by recommendation system 630, where N is a predefined threshold parameter. Retrieval agent 640 filters restaurant menus 620 to narrow the context for LLM 660, thus improving speed and accuracy.

Below is an example database query that limits, in the search stage, the results of the vector store search to menus of restaurants predicted by recommendation system 630. In step 4, prompt augmentation component 650 provides the results (i.e., matching documents) of the vector store search to LLM 660 as context. LLM 660 then gives the personalized menu items (e.g., tofu curry, tofu biryani, peas curry) as the recommendations 670 back to user 105. Note that the query is sensitive to the user's location. The database query may be as follows:

```
SELECT GROUP_CONCAT(t1.text) INTO @context
  FROM (
    SELECT segment as text
      FROM restaurant_menus
      WHERE restaurant_name IN [RESULTS FROM RECOMMENDER SYSTEM]
      ORDER BY DISTANCE (segment_embedding, @query_embedding,
“COSINE”)
      LIMIT 5)
  AS t1;
```

The result of the database query is “@context,” from which prompt augmentation component 650 can generate a prompt that the generative model accepts as input. In one embodiment, a prompt template is used, such as the prompt template shown in FIG. 4. The result of the database query can be provided in the context portion 420, and the user's query can be provided in the question portion 430. In an embodiment, the output of LLM 660 (i.e., recommendations 670) may be prose that lists and describes: (a) suitable nearby restaurants that are currently open and (b) recommended dishes from those suitable restaurants that are predicted to be preferred by the user.

### Dbms Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables, and other information.

A database server includes multiple database processes. Database processes run under the control of the database server (i.e., can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., .java file) and the compiled version of the class (i.e., .class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

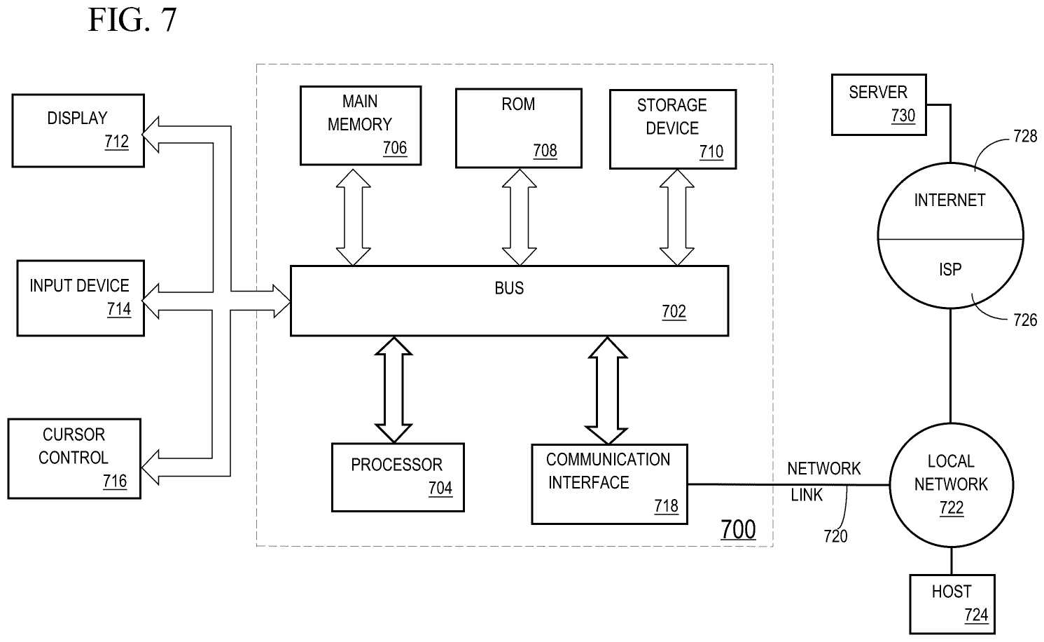

For example, FIG. 7 is a block diagram that illustrates a computer system 700 upon which aspects of the illustrative embodiments may be implemented. Computer system 700 includes a bus 702 or other communication mechanism for communicating information, and a hardware processor 704 coupled with bus 702 for processing information. Hardware processor 704 may be, for example, a general-purpose microprocessor.

Computer system 700 also includes a main memory 706, such as a random-access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world-wide packet data communication network now commonly referred to as the “Internet” 728. Local network 722 and Internet 728 both use electrical, electromagnetic, or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### Machine Learning Model

A machine learning model is trained using a particular machine learning algorithm. Once trained, input is applied to the machine learning model to make an inference, which may also be referred to herein as an inference output or output.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data are used by a supervised training algorithm to train a machine learning model. The training data includes input and “known” output. In an embodiment, the supervised training algorithm is an iterative procedure. In each iteration, the machine learning algorithm applies the model artifact and the input to generate an inference. An error or variance between the inference output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, executed, and/or as generating an output or inference, a computer system process executing a machine learning algorithm applies the model artifact against the input to generate an inference output. A computer system process executes a machine learning algorithm by executing software configured to cause execution of the algorithm.

Classes of problems that machine learning (ML) excels at include clustering, classification, regression, anomaly detection, prediction, and dimensionality reduction (i.e., simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e., configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

A machine learning engine may include one or more of an input/output module, a data preprocessing module, a model selection module, a training module, an evaluation and tuning module, and/or an inference module. In accordance with an embodiment, an input/output module serves as the primary interface for data entering and exiting the system, managing the flow and integrity of data. This module may accommodate a wide range of data sources and formats to facilitate integration and communication within the machine learning architecture.

In accordance with an embodiment, the data preprocessing module transforms data into a format suitable for use by other modules in the machine learning engine. For example, the data preprocessing module may transform raw data into a normalized or standardized format suitable for training ML models and for processing new data inputs for inference. In an embodiment, the data preprocessing module acts as a bridge between the raw data sources and the analytical capabilities of machine learning engine.

In an embodiment, the data preprocessing module begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. The data preprocessing module may be configured to handle anomalies in different ways depending on context. The data preprocessing module also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, the data preprocessing module includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when the data preprocessing module processes new data for inference, the data preprocessing module replicates the same preprocessing steps to ensure consistency with the training data format. This helps to avoid discrepancies between the training data format and the inference data format, thereby reducing the likelihood of inaccurate or invalid model predictions.

In an embodiment, a model selection module includes logic for determining the most suitable algorithm or model architecture for a given dataset and problem. This module operates in part by analyzing the characteristics of the input data, such as its dimensionality, distribution, and the type of problem (classification, regression, clustering, etc.).

In accordance with an embodiment, the training module manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. The training module handles the iterative process of feeding the training data into the model, adjusting the model's internal parameters (like weights in neural networks) through backpropagation and optimization algorithms, such as stochastic gradient descent or other algorithms providing similarly useful results.

In an embodiment, the training module includes logic to handle different types of data and learning tasks. For instance, it includes different training routines for supervised learning (where the training data comes with labels) and unsupervised learning (without labeled data). In the case of deep learning models, the training module also manages the complexities of training neural networks that include initializing network weights, choosing activation functions, and setting up neural network layers.

In an embodiment, an inference module transforms raw data into actionable, precise, and contextually relevant inferences. In addition to processing and applying a trained model to new data, the inference module may also include post-processing logic that refines the raw outputs of the model into meaningful insights.

In an embodiment, the inference module includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, the inference module transforms the outputs of a trained model into definitive classifications. The inference module employs the underlying model as a tool to generate probabilistic outputs for each potential class. It then engages in an interpretative process to convert these probabilities into concrete class labels.

In an embodiment, the inference module incorporates domain-specific adjustments into its post-processing routine. This involves tailoring the model's output to align with specific industry knowledge or contextual information. For example, in financial forecasting, the inference module may adjust predictions based on current market trends, economic indicators, or recent significant events, ensuring that the outputs are both statistically accurate and practically relevant.

In an embodiment, the inference module includes logic to handle uncertainty and ambiguity in the model's predictions. In cases where the inference module outputs a measure of uncertainty, such as in Bayesian inference models, the inference module interprets these uncertainty measures by converting probabilistic distributions or confidence intervals into a format that can be easily understood and acted upon. This provides users with both a prediction and an insight into the confidence level of that prediction. In an embodiment, the inference module includes mechanisms for involving human oversight or integrating the instance into a feedback loop for subsequent analysis and model refinement.

In an embodiment, the inference module formats the final predictions for end-user consumption. Predictions are converted into visualizations, user-friendly reports, or interactive interfaces. In some systems, like recommendation engines, the inference module also integrates feedback mechanisms, where user responses to the predictions are used to continually refine and improve the model, creating a dynamic, self-improving system.

### Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 120, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 122 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 124, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 126, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 128 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 130, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### Software Overview

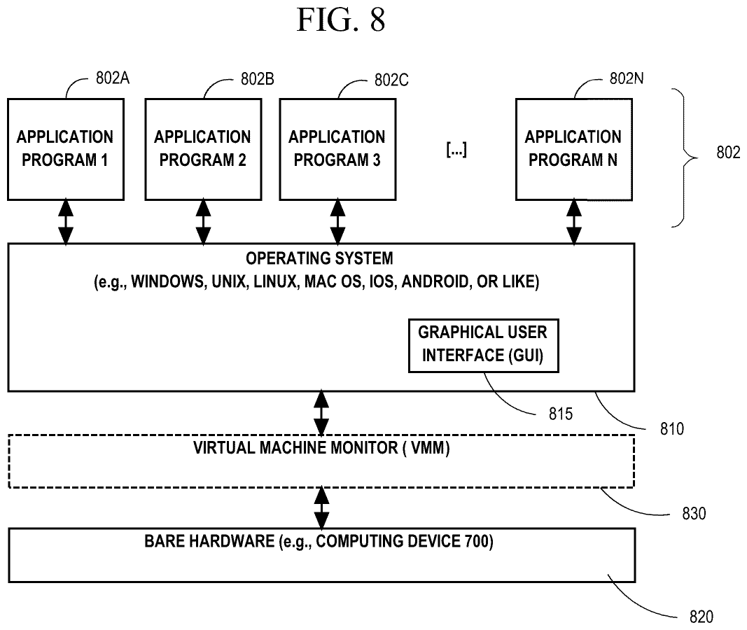

FIG. 8 is a block diagram of a basic software system 800 that may be employed for controlling the operation of computer system 700 upon which aspects of the illustrative embodiments may be implemented. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computer system 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 710 into memory 706) for execution by system 800. The applications or other software intended for use on computer system 700 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of computer system 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the computer system 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of computer system 800 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
accessing one or more inferences generated using a machine learning (ML) model;
providing an inference input to a retrieval agent of an object store based on the one or more inferences, wherein:
the object store comprises one or more vector stores representing a plurality of reference documents using semantic encodings, and
the retrieval agent performs a similarity search of the one or more vector stores to retrieve a set of passages from the plurality of reference documents based at least in part on similarity of encodings of the inference input and encodings of passages in the plurality of reference documents;
generating a linguistic prompt for a large language model (LLM) having a context including the one or more inferences and the set of passages;
applying the LLM to the linguistic prompt to generate a natural language explanation of the one or more inferences; and
causing the natural language explanation of the one or more inferences to be stored,
wherein the method is performed by one or more computing devices.

2. The method of claim 1, further comprising:
receiving a natural language query from the user, wherein:
the machine learning model generates the one or more inferences based at least in part on a profile of the user, and
generating the linguistic prompt comprises adding the natural language query to the linguistic prompt.

3. The method of claim 2, wherein:
the natural language query comprises a request for a product recommendation,
the ML model is part of an ML-based recommendation system,
the plurality of reference documents comprises a plurality of product descriptions, and
the retrieval agent performs the similarity search based at least in part on the natural language query.

4. The method of claim 1, wherein:
the LLM is applied to the linguistic prompt using a query acceleration engine, and
the query acceleration engine comprises the retrieval agent and the LLM.

5. The method of claim 1, wherein the ML model is part of an anomaly detection system,
wherein the method further comprises:
continuously monitoring, by the anomaly detection system, a series of logs; and
in response to detection of one or more anomalous logs in the series of logs, generating, by the anomaly detection system, a trigger condition;
wherein the one or more inferences identify the one or more anomalous logs; and
wherein the linguistic prompt is generated in response to the trigger condition.

6. The method of claim 5, wherein:
the plurality of reference documents comprises at least one of:
manuals,
troubleshooting cheat sheets,
frequently asked questions (FAQ) documents,
discussion forums,
tutorials, or
weblog posts.

7. The method of claim 5, wherein performing the similarity search comprises:
generating one or more log embeddings based on the one or more anomalous logs; and
selecting the set of passages based at least in part on similarity of embeddings of passages in the plurality of reference documents to the one or more log embeddings.

8. The method of claim 1, wherein the ML model is part of a fraud detection system,
wherein the method further comprises:
continuously monitoring, by the fraud detection system, a series of financial transactions; and
in response to detection of one or more anomalous transactions in the series of financial transactions, generating, by the fraud detection system, a trigger condition;
wherein the one or more inferences comprise the one or more anomalous transactions; and
wherein the linguistic prompt is generated in response to the trigger condition.

9. The method of claim 1, wherein performing the similarity search comprises:
generating a sequence of lexical tokens based on the one or more inferences;
generating a search encoding that represents the sequence of lexical tokens; and
selecting, by the retrieval agent, the set of passages based at least in part on similarity of the search encoding and encodings of the set of passages.

10. The method of claim 1, wherein the linguistic prompt is based on an engineered prompt template comprising:
a natural language command,
one or more guardrails limiting a scope of output,
a context portion, and
a user query portion.

11. One or more non-transitory computer-readable media storing instructions which, when executed by one or more processors, cause performance of:
accessing one or more inferences generated using a machine learning (ML) model;
providing an inference input to a retrieval agent of an object store based on the one or more inferences, wherein:
the object store comprises one or more vector stores representing a plurality of reference documents using semantic encodings, and
the retrieval agent performs a similarity search of the one or more vector stores to retrieve a set of passages from the plurality of reference documents based at least in part on similarity of encodings of the inference input and encodings of passages in the plurality of reference documents;
generating a linguistic prompt for a large language model (LLM) having a context including the one or more inferences and the set of passages;
applying the LLM to the linguistic prompt to generate a natural language explanation of the one or more inferences; and
causing the natural language explanation of the one or more inferences to be stored.

12. The one or more non-transitory computer-readable media of claim 11, wherein the instructions further cause performance of:
receiving a natural language query from the user, wherein:
the machine learning model generates the one or more inferences based at least in part on a profile of the user, and
generating the linguistic prompt comprises adding the natural language query to the linguistic prompt.

13. The one or more non-transitory computer-readable media of claim 12, wherein:
the natural language query comprises a request for a product recommendation;
the ML model is part of an ML-based recommendation system;
the plurality of reference documents comprises a plurality of product descriptions; and
the retrieval agent performs the similarity search based at least in part on the natural language query.

14. The one or more non-transitory computer-readable media of claim 11, wherein:
the LLM is applied to the linguistic prompt using a query acceleration engine, and
the query acceleration engine comprises the retrieval agent and the LLM.

15. The one or more non-transitory computer-readable media of claim 11, wherein the ML model is part of an anomaly detection system;
wherein the instructions further cause performance of:
continuously monitoring, by the anomaly detection system, a series of logs; and
in response to detection of one or more anomalous logs in the series of logs, generating, by the anomaly detection system, a trigger condition;
wherein the one or more inferences identify the one or more anomalous logs; and
wherein the linguistic prompt is generated in response to the trigger condition.

16. The one or more non-transitory computer-readable media of claim 15, wherein:
the plurality of reference documents comprises at least one of:
manuals,
troubleshooting cheat sheets,
frequently asked questions (FAQ) documents,
discussion forums,
tutorials, or
weblog posts.

17. The one or more non-transitory computer-readable media of claim 15, wherein performing the similarity search comprises:
generating one or more log embeddings based on the one or more anomalous logs; and
selecting the set of passages based at least in part on similarity of embeddings of passages in the plurality of reference documents to the one or more log embeddings.

18. The one or more non-transitory computer-readable media of claim 11, wherein the ML model is part of a fraud detection system,
wherein the instructions further cause performance of:
continuously monitoring, by the fraud detection system, a series of financial transactions; and
in response to detection of one or more anomalous transactions in the series of financial transactions, generating, by the fraud detection system, a trigger condition;
wherein the one or more inferences comprise the one or more anomalous transactions; and
wherein the linguistic prompt is generated in response to the trigger condition.

19. The one or more non-transitory computer-readable media of claim 11, wherein performing the similarity search comprises:
generating a sequence of lexical tokens based on the one or more inferences;
generating a search encoding that represents the sequence of lexical tokens; and
selecting, by the retrieval agent, the set of passages based at least in part on similarity of the search encoding and encodings of the set of passages.

20. The one or more non-transitory computer-readable media of claim 11, wherein the linguistic prompt is based on an engineered prompt template comprising:
a natural language command,
one or more guardrails limiting a scope of output,
a context portion, and
a user query portion.
